(19) United States
(12) Patent Application Publication
(10) Pub. No.: US 2026/0031552 A1
(43) Pub. Date: Jan. 29, 2026

(54) CONNECTION ASSEMBLY WITH A PLURALITY OF CONNECTION TERMINALS FOR CONNECTING ELECTRICAL WIRES

(71) Applicant: PHOENIX CONTACT GMBH & CO. KG, Blomberg (DE)

(72) Inventors: Dennis GEISLER, Extertal (DE); Sebastian SCHÄFER, Blomberg (DE)

(21) Appl. No.: 18/997,098

(22) PCT Filed: Jul. 20, 2023
(86) PCT No.: PCT/EP2023/070126

§ 371 Date: Jan. 20, 2025

(30) Foreign Application Priority Data
Jul. 21, 2022 (LU) LU502541

(51) Int. Cl. H01R 9/24; H01R 9/22

(52) U.S. Cl. CPC H01R 9/2416; H01R 9/223

(57) ABSTRACT

A connection assembly includes: a plurality of connection terminals for connecting electrical wires, each connection terminal of the plurality of connection terminals having a housing part, a contact element arranged on the housing part with a contact portion for electrically contacting an electrical wire, and a spring element with a clamping leg which is adjustable relative to the housing part and which acts, in a clamping position, upon the electrical wire for contacting the contact portion; and an outer housing into which the housing parts, which are arranged in a row along a row direction, of the plurality of connection terminals are insertable in an assembly direction, the outer housing having a first guide device with at least one first guide web, the housing parts being arranged in the row having a second guide device with at least one second guide web.

### CROSS-REFERENCE TO PRIOR APPLICATIONS

This application is a U.S. National Phase application under 35 U.S.C. § 371 of International Application No. PCT/EP2023/070126, filed on Jul. 20, 2023, and claims benefit to Luxembourg Patent Application No. LU 502541, filed on Jul. 21, 2022. The International Application was published in German on Jan. 25, 2024 as WO/2024/017994 under PCT Article 21(2).

### FIELD

The invention relates to a connection assembly with a plurality of connection terminals for connecting electrical wires.

### BACKGROUND

Such a connection assembly comprises a plurality of connection terminals to which electrical wires can be plugged and connected. For this purpose, the connection terminals each have a housing part, a contact element arranged on the housing part with a contact portion for electrically contacting an electrical wire, and a spring element with a clamping leg that can be adjusted relative to the housing part. The clamping leg of the spring element is designed to act upon an electrical wire in a clamping position for contacting the contact portion.

By using the spring element, the connection terminals establish a spring force connection in which, in the connected position, the electrical wire is clamped to the contact element under the elastic action of the spring element and is thus electrically connected to the contact element.

In a connection terminal known from DE 10 2019 127 464 B3, a spring element in the form of a tension spring is provided, which pulls a connected electrical wire into abutment with an associated contact element by the resilient action of the spring and thus establishes a clamping connection between the electrical wire and the contact element. For this purpose, when attaching the electrical wire, it is pushed through an opening in the clamping leg and is clamped between the clamping leg and the contact element when in the connected position.

The connection terminal in DE 10 2019 127 464 B3 provides a locking device used to lock the clamping leg in a release position relative to the housing. When the electrical wire is inserted, the locking device is detached and the locking engagement is therefore released such that clamping leg is moved from the release position, and the electrical wire is thereby clamped to the contact element. In order to move the clamping leg into the release position, in particular to enable the electrical wire to be attached or to detach a connected electrical wire from the connection terminal, a tool, e.g., a screwdriver, can be attached to the connection terminal, and a force can thereby be exerted on the clamping leg.

While in DE 10 2019 127 464 B3, the clamping leg is directly moved by means of a tool, in each of the connection terminals known from DE 10 2019 135 203 A1 and DE 10 2020 104 140 A1, an actuation element in the form of a so-called pusher is provided which can be pushed into the housing of the connection terminal in order to thereby act upon the clamping leg and to transfer the clamping leg into its release position. The actuation element is spring-loaded relative to the housing of the connection terminal via a clamping spring in the form of a compression spring. In the connection terminal known from DE 10 2019 135 203 A1, an actuating lug is arranged on the actuation element, which hooks into a fastening portion of a retaining element when the actuation element is in the actuated position.

In the connection assembly, the housing parts of the connection terminals can be attached to one another along a row direction, so that a connection block is created which implements the connection assembly and to which a plurality of electrical wires can be connected. The connection terminals can thus be combined and arranged in series to create an assembly of a plurality of interconnected connection terminals. The connection terminals can be designed in a disk design (with a comparatively thin width and a disk-shaped extension along a plane perpendicular to the row direction) and are attached to one another to create the connection assembly.

The disk design of the connection terminals has the advantage that it increases the clearance, in order for example to facilitate the assembly of the contact element and the spring element on the housing part of the connection terminal. The housing part of a connection terminal can be designed in such a way that a (closed) housing for the connection terminals is only created when the housing parts of the connection terminals are attached to one another, and the housing part of a connection terminal is thus completed by the housing part of an adjacent connection terminal to create a closed housing.

There is a need to connect the connection terminals firmly and resiliently to one another to create the connection assembly so that a mechanically stable assembly is created.

DE 10 2009 013 689 A1 discloses a connection assembly with connection terminals that are set into a securing element. The securing element can, for example, be made in the shape of a hood.

### SUMMARY

In an embodiment, the present invention provides a connection assembly, comprising: a plurality of connection terminals configured to connect electrical wires, each connection terminal of the plurality of connection terminals having a housing part, a contact element arranged on the housing part with a contact portion configured to electrically contact an electrical wire, and a spring element with a clamping leg which is adjustable relative to the housing part and which is configured to act, in a clamping position, upon the electrical wire for contacting the contact portion; and an outer housing into which the housing parts, which are arranged in a row along a row direction, of the plurality of connection terminals are insertable in an assembly direction, the outer housing having a first guide device with at least one first guide web, the housing parts being arranged in the row having a second guide device with at least one second guide web, wherein the at least one second guide web of the second guide device is configured to be guided on the at least one first guide web of the first guide device when the housing parts arranged in the row are inserted into the outer housing in the assembly direction.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a view of a connection assembly with a plurality of connection terminals accommodated in an outer housing;

FIG. 2 is a side view of the connection assembly;

FIG. 3 shows the connection assembly according to FIG. 1 in an actuated position of actuation elements of the connection terminals;

FIG. 4 is a side view of the connection assembly according to FIG. 3;

FIG. 5 is a longitudinal sectional view through a connection terminal, in an actuated position of an actuation element;

FIG. 6A is a view of a housing part of a connection terminal;

FIG. 6B is a view of a housing part of an adjacent connection terminal;

FIG. 7A-7C are separate views of a detachment element of the connection terminal;

FIG. 8A is a view of a housing part of the connection terminal;

FIG. 8B is an enlarged view in detail X according to FIG. 7A;

FIG. 9 is a sectional view along the line I-I according to FIG. 2;

FIG. 10 is a sectional view along the line II-II according to FIG. 2;

FIG. 11 is a sectional view along the line III-III according to FIG. 10;

FIG. 12 is a separate view of the outer housing of the connection assembly;

FIG. 13A is a side view of the outer housing;

FIG. 13B is a front view looking into the outer housing;

FIG. 13C is a rear view of the outer housing; and

FIG. 14A-14C are separate views of a housing part of a connection terminal.

### DETAILED DESCRIPTION

In an embodiment, the present invention provides a connection assembly in which a plurality of connection terminals with housing parts can be combined with one another by arranging them in a row along a row direction, while creating a mechanically stable connection block.

Accordingly, the connection assembly has an outer housing into which the housing parts, arranged in a row along the row direction, of the connection terminals can be inserted in an assembly direction. The outer housing has a first guide device with at least one first guide web. The housing parts arranged in a row have a second guide device with at least one second guide web. The at least one second guide web of the second guide device is guided on the at least one first guide web of the first guide device when the housing parts arranged in a row are inserted into the outer housing in the assembly direction.

The connection assembly is created by attaching housing parts of connection terminals to one another along a row direction. In a position arranged in a row, the housing parts can be inserted into the outer housing of the connection assembly, so that, in an assembled position, the housing parts are received in the outer housing and are thus enclosed by the outer housing.

The outer housing can, for example, have a box shape that is open on one side, so that the housing parts arranged in a row can be inserted into the box-shaped outer housing. In another embodiment, the outer housing can, for example, have the shape of a frame that is open on two sides and into which the housing parts arranged in a row can be inserted.

The outer housing has a first guide device used to guide the housing parts arranged in a row and which interacts for this purpose with a second guide device of the housing parts arranged in a row. Each guide device has at least one guide web, wherein the guide webs are guided on one another when the housing parts arranged in a row are inserted into the outer housing, so that the housing parts arranged in a row are brought into engagement with the outer housing in a guided manner.

By providing the outer housing, the advantages of a disk design of the connection terminals and a so-called monoblock are combined.

Because the connection terminals are designed with individual housing parts and can be attached to one another along the row direction to create the connection assembly, the housing parts can be designed in such a way that the components of the connection terminals can be easily mounted on the corresponding housing part—for example, the spring element and the contact element. For example, the housing part of each connection terminal is not closed on the outside; rather, the housing of the connection terminals is completed only by attaching the housing parts of the connection terminals to one another. This results in simple assembly of the individual connection terminals and an ability to be combined in a variable manner with other connection terminals.

The fact that the connection terminals arranged in a row are enclosed in the outer housing in the assembled position also creates a mechanically stable assembly in which the housing parts of the connection terminals in the position in a row are accommodated in the housing and fixed to the housing in a defined manner. By being guided via the guide devices, the housing parts are introduced into the outer housing in a defined manner and are supported on the outer housing in the assembled position, so that a uniform connection assembly is created which is mechanically stable.

In one embodiment, at least one of the housing parts has at least one second guide web, which is guided on an associated first guide web of the first guide device. Advantageously, each of the housing parts has at least one second guide web, which is guided on a correspondingly associated first guide web of the first guide device. Thus, one (or all) of the housing parts are guided on the outer housing.

In one embodiment, the at least one of the housing parts, preferably each of the housing parts, has a wall extending along a plane perpendicular to the row direction, from which wall the at least one second guide web protrudes along the row direction. The housing part of (each) connection terminal can have a disk shape in which the wall of the housing part extends perpendicular to the row direction and in the plane perpendicular to the row direction has a size which is (significantly) larger than the width of the connection terminal (measured along the row direction). The guide web assigned to the housing part protrudes from the wall along the row direction and is thus formed laterally on the wall.

Preferably, two second guide webs are formed on at least one of the housing parts, preferably on a plurality of the housing parts, of the connection terminals, which second guide webs are arranged on opposite sides of the wall. The guide webs each protrude from the wall along the row direction, but point in different, opposite directions. Each guide web is guided on an associated guide web of the first guide device of the outer housing when the housing parts arranged in a row are pushed into the outer housing, so that a reliable guidance with mechanically stable support in the assembled position is provided.

Guide webs can be formed on an upper edge, pointing along the assembly direction, of the wall and/or on a parallel lower edge, pointing along the assembly direction, of the wall and can protrude from the wall on one or both sides. Each guide web of the housing part is guided on an associated guide web on the outer housing.

In one embodiment, the at least one first guide web and/or the at least one second guide web form a dovetail guide. If, for example, two second guide webs are formed on the wall of the housing part of a connection terminal, which protrude from the wall along the row direction and point in different directions, the guide webs can together form in cross-section a trapezoidal shape, which provides a dovetail guide. Analogously, for example, two first guide webs are formed on a wall of the outer housing, which webs together form a trapezoidal shape with which the second guide webs of the corresponding housing part can be brought into engagement, so that, when the housing parts are inserted into the outer housing, a guide is provided, and, in the assembled position, the assembly of the housing parts is mechanically supported stably on the outer housing.

The row direction and the assembly direction are preferably perpendicular to each other. The (disk-shaped) connection terminals are attached to one another along the row direction by arranging the housing parts in a row along the row direction. In a position arranged in a row, the housing parts are pushed into the outer housing in the assembly direction perpendicular to the row direction, so that, in the assembled position, the housing parts are enclosed in the outer housing.

Here, the at least one first guide web and the at least one second guide web are advantageously undercut with respect to a vertical direction perpendicular to the assembly direction and to the row direction, so that the at least one first guide web and the at least one second guide web are supported relative to one another along the vertical direction. The guide bars protrude relative to a plane spanned by the vertical direction and the assembly direction, so that the guide webs engage behind each other. With respect to the vertical direction, the guide webs here form an undercut by springing back along the row direction, so that the guide webs engage with each other and are supported against each other in a plane spanned by the row direction and the vertical direction. The guide bars can be moved relative to each other along the assembly direction, but are supported against each other in a form-fitting manner in the plane perpendicular to the assembly direction.

In one embodiment, the spring element of at least one of the connection terminals is designed as a tension spring. In this case, the clamping leg of the spring element is designed to pull the electrical wire into abutment with the contact element by spring force. In this case, for example, an opening can be formed in the clamping leg through which the electrical wire can be guided, when it is plugged into the connection terminal, in order to pull the electrical wire into clamping contact with the contact element after the clamping leg has been detached from the release position.

Alternatively, the spring element of at least one of the connection terminals can be designed as a compression spring. In this case, the clamping leg is designed to push the electrical wire into abutment with the contact element by spring force. When plugged into the connection terminal, the electrical wire enters a space between the clamping leg and the contact element, wherein, after the clamping leg has been detached from the release position, the clamping leg acts upon the electrical wire and pushes it into abutment with the contact element.

The spring element can, for example, have a supporting leg via which the spring element is supported on the housing and held in position on the housing. The clamping leg can be elastically deflected relative to the supporting leg, wherein, in the release position, the clamping leg is deflected such that the spring element is elastically loaded, and the clamping leg is moved out of the release position under elastic preload after being detached from the release position.

The supporting leg can, for example, rest against a supporting portion and is supported thereabove on the housing part. The spring element is thus attached to the housing part independently of the contact element and is therefore not directly electrically connected to the contact element if the housing part is made of an electrically insulating material, in particular a plastic material.

In one embodiment, the supporting leg of the spring element of at least one of the connection terminals is supported on the housing part associated with the connection terminal and on the housing part of a connection terminal that is adjacent along the row direction. The supporting leg is thus supported on the housing part of the associated connection terminal and rests, for example, on a supporting portion on a wall of the housing part. In addition, the supporting leg is also supported on the housing part of an adjacent connection terminal and, for example, rests on a supporting portion on a wall of the adjacent housing part. The supporting leg is thus supported jointly on two housing parts of adjacent connection terminals.

The electrical wire in the connection terminals is electrically contacted by the electrical contact element by the clamping leg acting upon the electrical wire when said electrical wire is plugged into the connection terminal and applying an elastic load thereto in the direction of contact with the contact element. To make it easier to attach the electrical wire, the clamping leg of the spring element can be elastically deflected, e.g., using a tool or by actuating an actuation element, in order to thereby move the clamping leg into a release position in which a space in the region of an insertion opening is cleared, and the electrical wire can accordingly be inserted into the insertion opening substantially without any force, or a connected electrical wire can be easily removed from the connection terminal.

If the clamping leg has been transferred to the release position, the clamping leg of at least one of the connection terminals is, in one embodiment, held in the release position relative to the housing part associated with the corresponding connection terminal. This can be done by directly locking the clamping leg relative to the housing part or by indirect locking—for example, via an actuation element.

In one embodiment, at least one of the connection terminals has a detachment element which is designed to interact with the electrical wire when plugged into the connection terminal to detach the clamping leg from the release position. In so doing, the detachment element also serves to detach the clamping leg from the release position in order to automatically release the clamping leg from the release position when the electrical wire is inserted and thus to transfer the clamping leg into a clamping position in which the electrical wire inserted into the insertion opening is electrically contacted by the contact element of the connection terminal. Since the detachment element is deflected when the electrical wire is inserted, the connection terminal closes automatically when the electrical wire is inserted. This results in a simple connection process, with reliable contacting of the wire with the contact element.

Such a connection terminal, in which the clamping leg of the spring element is held in position relative to the housing part in the release position and which can be automatically detached via a detachment element when an electrical wire is inserted, can be delivered by a manufacturer with the clamping leg in the release position, for example.

In one embodiment, the detachment element comprises a detachment leg which is designed to interact with the electrical wire when plugged into the connection terminal. By interacting with the electrical wire, the detachment leg is detached, so that the clamping leg is released from the release position. The housing part of the at least one connection terminal defines a receiving space into which the electrical wire can be introduced by inserting it into an insertion opening. The detachment leg extends into the receiving space to interact with the electrical wire. In particular, the electrical wire can be inserted into the insertion opening along an insertion direction, wherein the detachment leg extends with an end portion (approximately) transversely to the insertion direction within the receiving space.

The detachment element can, for example, be designed as an integral, inherently elastically springy element.

In one embodiment, the detachment element has a support end, relative to which the detachment leg is elastically adjustable by interaction with the wire connected to the connection terminal. The detachment element is supported on the housing part via the support end—for example, by the support end being fastened to an associated connecting device of the housing part of the at least one connection terminal. The detachment element is thus fastened to the housing part via the supporting end by the supporting end being operatively connected to a connecting device of the housing part, and is thereabove held on the housing part in a torque-tight manner.

The support end is preferably fixed in a torque-tight manner to the connecting device of the housing part of the at least one connection terminal. The supporting end can extend flat, which has the advantage that a contour can be formed at the supporting end in a simple manner, e.g., by punching, via which contour it can be reliably, e.g., form-fittingly, fixed to the connecting device of the housing part. While the supporting end is supported in a torque-tight manner relative to the housing part, the detachment leg can be elastically moved in the receiving space and extends in the receiving space in such a way that an electrical wire inserted into the connection terminal strikes the detachment leg when introduced into the receiving space and thus deflects it.

In one embodiment, the supporting end has at least one first form-fitting element, while the connecting device of the housing part of the at least one connection terminal comprises at least one second form-fitting element. The at least one first form-fitting element and the at least one second form-fitting element form-fittingly engage with one another to fix the supporting end to the housing part. This creates a form-fitting connection between the supporting end and the housing part of the at least one connection terminal such that the supporting end is held on the housing part in a torque-tight manner. The detachment leg can be elastically deflected relative to the supporting leg, wherein the supporting end is fixed to the housing part in such a way that a torque can be introduced into the housing part via the supporting end and is supported on the housing part.

One of the form-fitting elements can be formed by a recess, for example. The other form-fitting element is then formed by a projection element which form-fittingly engages in the recess to fix the supporting end to the housing part. For example, the supporting end may have a recess which, with an associated form-fitting element in the form of a projection element, engages on the housing part. The form-fitting engagement is in particular such that the supporting end cannot slide off the housing part, but is held on the housing part in such a way that, when the detachment leg is elastically deflected, the supporting end remains in position on the housing part of the at least one connection terminal.

In one embodiment, the support end of the detachment element of at least one of the connection terminals is supported on the housing part assigned to the connection terminal and the housing part of a connection terminal adjacent along the row direction. The support end is thus supported on the housing part of the associated connection terminal and, for example, engages in an engagement opening on a wall of the housing part. In addition, the support end is also supported on the housing part of an adjacent connection terminal and, for example, engages in an engagement opening on a wall of the adjacent housing part. The support end is thus supported jointly on two housing parts of adjacent connection terminals.

In one embodiment, at least one of the connection terminals has an actuation element which is adjustably arranged on the housing part and which can be adjusted from a non-actuated position to an actuated position in order to transfer the clamping leg into the release position. The actuation element can be actuated by a user, e.g., manually or by means of a suitable tool, and for this purpose has an actuating portion which is accessible from outside the housing part.

In one embodiment, the actuation element locks in the actuated position with the detachment element of the at least one of the connection terminals. In the actuated position, the actuation element is accordingly held in position by the detachment element such that the clamping leg of the spring element is thereabove also held in its release position in which it is possible to easily attach an electrical wire to the connection terminal or to remove a connected wire from the connection terminal substantially without any force. After releasing the locking engagement, the actuation element can move back, in particular automatically, towards the non-actuated position, preferably under spring preload. The actuation element can be subjected to spring preload, for example, by the clamping leg, which is elastically deflected in the actuated position and, after the actuation element has been released, acts upon the actuation element in a resiliently mechanical manner to transfer the actuation element from the actuated position towards the non-actuated position.

In one embodiment, the actuation element of the at least one of the connection terminals is mounted on the housing part of the at least one of the connection terminals so as to be pivotable around a pivot shaft and has an actuating portion for actuation by a user and an active portion for acting upon the clamping leg. While the actuating portion is accessible from outside the housing part, e.g., by a user being able to act upon the actuating portion using a tool, such as a screwdriver, or, alternatively, manually, the active portion is operatively connected to the clamping leg of the spring element. By moving the actuation element, a movement force is thus exerted on the clamping leg via the active portion such that, in particular when the actuation element is moved from the non-actuated position into the actuated position, the clamping leg is entrained and is thus moved in the direction of the release position.

In one embodiment, the actuation element has a locking portion for engaging with a locking device of the detachment element of the at least one of the connection terminals when in the actuated position. The locking portion can, for example, be arranged on a side, facing away from the actuating portion, of the actuation element (with respect to the pivot shaft of the pivotable bearing for the actuation element on the housing part), preferably approximately diametrically remote from the actuating portion with respect to the pivot shaft. By means of the locking portion, the actuation element is locked in the actuated position by an associated locking device of the detachment element such that the actuation element is thereabove held in the actuated position, but can be detached from the actuated position in a simple and reliable manner by detaching the detachment leg when the electrical wire is inserted.

The locking device of the detachment element can be formed, for example, by an opening in which the locking portion of the actuation element, e.g., formed by a projection, engages when the actuation element is in the actuated position. The actuation element is thus held in position in its actuated position by the form-fitting engagement of the locking portion in the opening of the detachment element, wherein the engagement can be released by adjusting the detachment leg, and the actuation element can thus be detached from the actuated position to transfer the clamping leg into the release position.

In one embodiment, the actuation element of at least one of the connection terminals is mounted on the housing part associated with the at least one connection terminal and the housing part of a connection terminal adjacent along the row direction. Housing parts of adjacent connection terminals thus jointly support the actuation element between them. For example, each housing part can have a shaft journal that engages in a bearing opening on the actuation element, so that thereabove a pivot bearing for the actuation element is provided between the housing parts.

In one embodiment, the housing part of at least one of the connection terminals has a first locking element. In contrast, a housing part of a connection terminal adjacent along the row direction has a second locking element. The first locking element and the second locking element are locked together when the housing parts of the connection terminals are arranged in a row along the row direction.

One of the locking elements can, for example, be realized by a locking opening. The other locking element, on the other hand, can be formed, for example, by an elastically deflectable locking hook. In a locked position, the locking elements are in engagement with each other and thus create a form-fitting connection between the housing parts of the connection terminals.

The locking elements can, for example, be capable of being brought into engagement with one another along the row direction, so that the housing parts can be attached to one another along the row direction.

For example, all housing parts can have at least one locking element, so that, when the housing parts of the connection terminals are attached to one another, the housing parts are locked together and thus secured to one another.

The locking elements can be used to position and hold the housing parts relative to one another, particularly before insertion into the outer housing, so that an assembly of connection terminals is created which can be inserted together into the outer housing. This results in easy handling for assembly, but also increased stability when using the connection assembly.

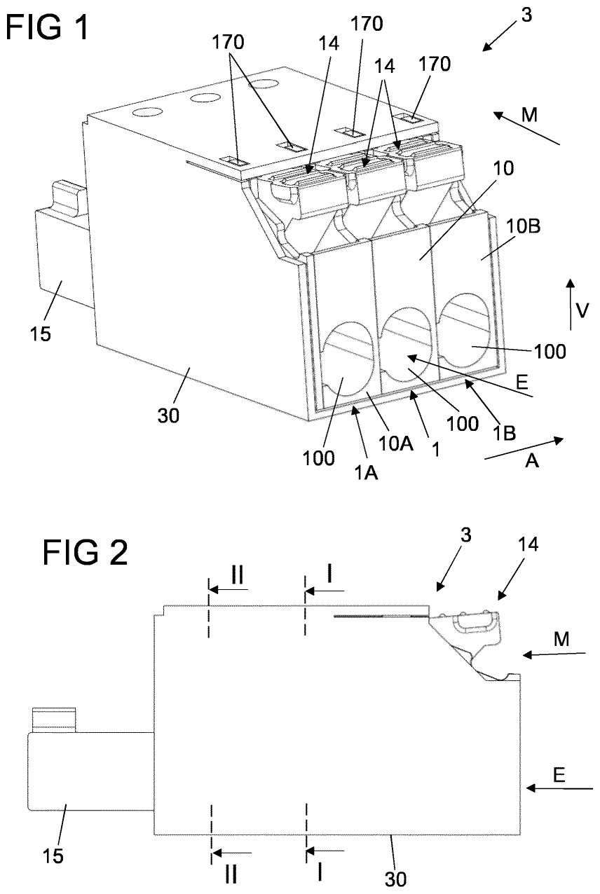

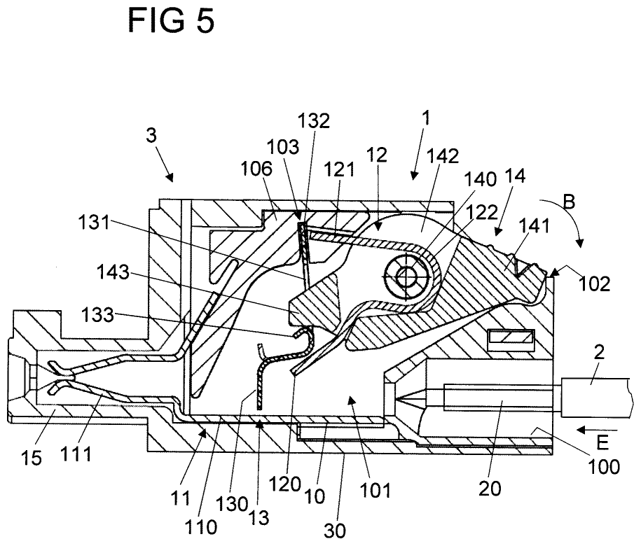

FIGS. 1 to 4 show an exemplary embodiment of a connection assembly 3 which has a plurality of connection terminals 1, 1A, 1B which are jointly enclosed by an outer housing 30. The connection terminals 1, 1A, 1B are arranged in a row in a row direction A and are jointly enclosed by the outer housing 30, wherein each connection terminal 1, 1A is assigned an insertion opening 100 in a correspondingly associated housing part 10, 10A, 10B, into which an electrical wire 2 can be inserted in an insertion direction E by means of a (stripped) conductor end 20 in order to connect the electrical wire 2 to the connection terminal 1, 1A, 1B.

FIG. 5 shows, in a sectional view, an exemplary embodiment of a connection terminal 1 which has a housing part 10 with an insertion opening 100 formed therein for inserting an electrical wire 2 in an insertion direction E. The other connection terminals 1A, 1B can be identical in construction and function to connection terminal 1, so that the following explanations apply to all connection terminals 1, 1A, 1B.

However, it is also conceivable for the connection terminals 1, 1A, 1B to differ in their functionality and in particular to not have all of the components described below.

The housing part 10 defines a receiving space 101 into which the electrical wire 2 is introduced by means of a stripped conductor end 20 when it is inserted into the insertion opening 100 in the insertion direction E. In a connected position, the wire 2 with the stripped conductor end 20 is located within the receiving space 101 and is electrically contacted via a clamping leg 120 of a spring element 12 by a contact element 11 in the form of a current bar such that the electrical wire 2 is electrically connected to the connection terminal 1.

The spring element 12 has a supporting leg 121 which is supported on a wall 106 of the housing 10. The clamping leg 120 can be elastically deflected relative to the supporting leg 121, in particular such that the clamping leg 120 clamps, in a clamping position, an electrical wire 2 connected to the connection terminal 1 and pushes this under elastic preload into contact with the contact element 11, and thus brings the wire 2 into electrical contact with the contact element 11 via its conductor end 20.

The contact element 11 has a contact portion 110 which extends in the housing part 10 in a planar manner and against which the conductor end 20 of the electrical wire 2 is pressed by spring preload of the clamping leg 120 when the electrical wire 2 is connected to the connection terminal 1. The contact portion 110 is connected to a contacting device 111 arranged in a plug connector portion 15, via which contacting device the connection terminal 1 can be plugged into an associated mating electrical connector.

In the exemplary embodiment shown, an actuation element 14 is pivotably mounted on the housing part 10 of the connection terminal 1 via a pivot shaft 140. The actuation element 14 can be pivoted around the pivot shaft 140 relative to the housing part 10, wherein an actuating portion 141 is accessible from outside the housing part 10 via an actuating opening 102 and can thus be actuated by a user—for example, using a tool.

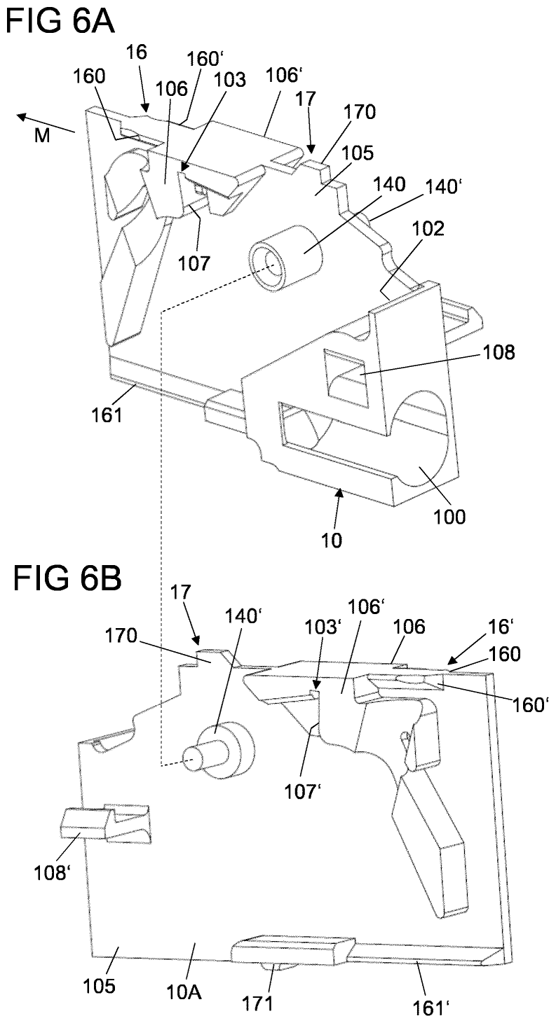

In the illustrated exemplary embodiment, the pivot shaft 140 is formed on the housing part 10 associated with a connection terminal 1, in which housing part a shaft journal 140′ of the housing part 10A of the adjacent connection terminal 1A engages and thus completes the pivot bearing of the actuation element 14 on the housing part 10, as can be seen from FIGS. 6A and 6B.

The actuation element 14 is operatively connected to the clamping leg 120 of the spring element 12. For this purpose, the spring element 12 passes through a through-opening 142 inside the actuation element 14 such that the spring element 12 grasps around the pivot shaft 140 by means of a curved intermediate portion 122, as can be seen from FIG. 5. The supporting leg 121 protrudes from the opening 142 on a first side and is supported on the housing part 10. The clamping leg 120, on the other hand, protrudes from the actuation element 14 on a remote second side and thus extends within the receiving space 101 in the region of the insertion opening 100 in such a way that the spring element 12 can act via the clamping leg 120 upon an electrical wire 2 inserted into the insertion opening 100 for contacting the contact element 11 and also for mechanical locking.

The connection terminal 1 has a detachment element 13 which is fastened to the housing 10 via a supporting end 132 and is thereby supported in a torque-tight manner relative to the housing part 10. A detachment leg 130 extends from the supporting end 132 and projects into the receiving space 101 substantially transversely to the insertion direction E and thus extends in a region aligned with the insertion opening 100.

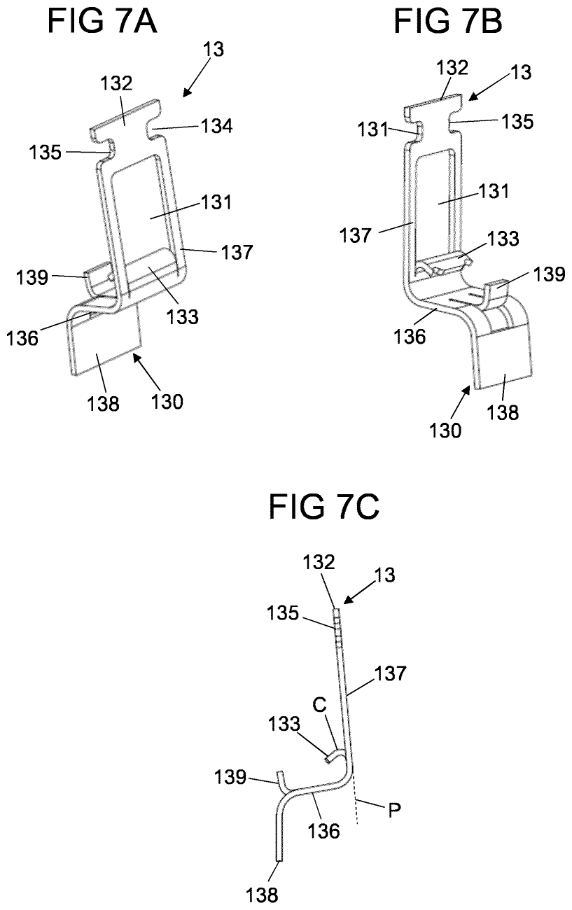

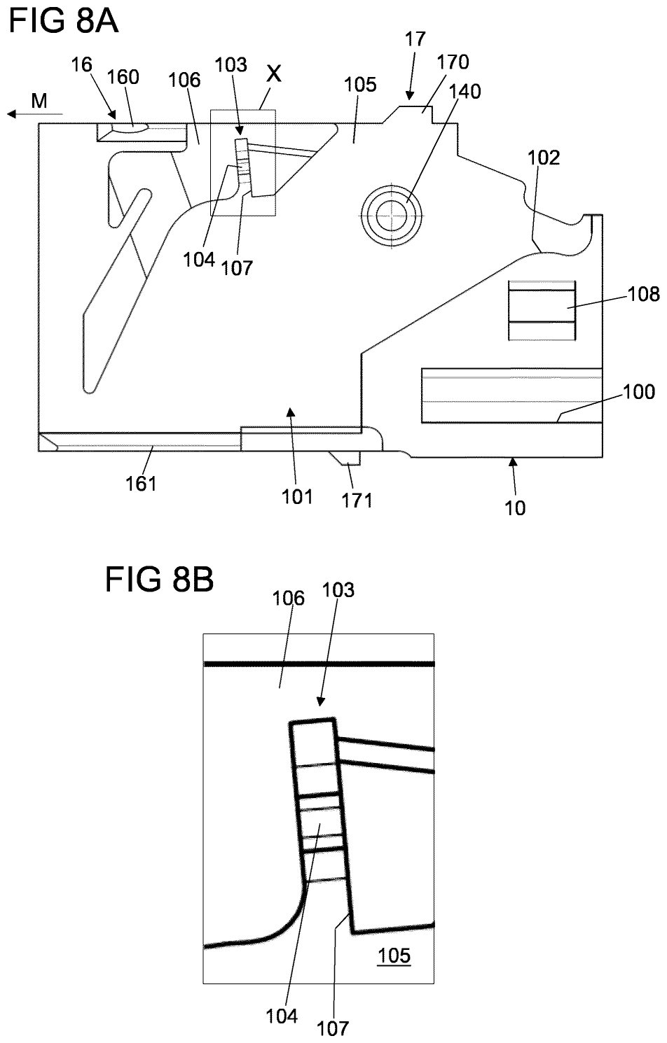

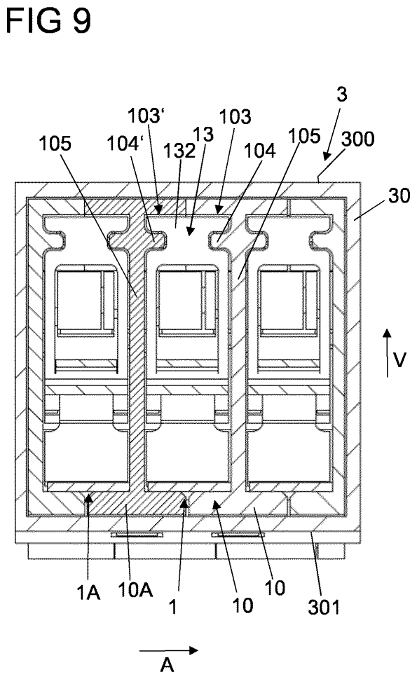

As can be seen from the separate view of the detachment element 13 according to FIG. 7A-7C, the detail views of the housing parts 10, 10A of the connection terminals 1, 1A according to FIG. 8A, 8B, and the sectional view according to FIG. 9, the supporting end 132 of the detachment element 13 is form-fittingly connected to connecting devices 103, 103′ of adjacent housing parts 10, 10A. The supporting end 132 of the detachment element 13 formed by a strip-shaped spring element has recesses 134, 135 in its opposite lateral edges, which, in the mounted position of the detachment element 13, engage with projection elements 104, 104′ on the connecting devices 103, 103′.

The connecting devices 103, 103′ are each formed by an engagement opening 107, 107′ into which the supporting end 132 engages such that the supporting end 132 is form-fittingly received on the housing part 10. The supporting end 132 is form-fittingly connected to the housing part 10 such that the supporting end 132 cannot slide out of the connecting devices 103, 103′ and, in addition, the supporting end 132 is supported on the housing part 10 in such a way that, when the detachment leg 130 is elastically deflected, torques can be absorbed at the supporting end 132 and diverted into the housing part 10, while the supporting end 132 remains in position relative to the housing part 10.

The engagement opening 107, 107′ is formed in a wall portion 106, 106′ of each housing part 10, 10A, which protrudes from a planar side wall 105 of the housing part 10, 10A, as can be seen from FIGS. 6A and 6B.

As can be seen from the sectional view according to FIG. 9, the supporting end 132 of the connection terminal 1 is received between the housing parts 10, 10A of the adjacent connection terminals 1, 1A such that the supporting end 132 is form-fittingly held on the connecting devices 103, 103′ that mirror each other of the housing parts 10, 10A of the connection terminals 1, 1A.

The detachment leg 130 serves to interact with an electrical wire 2 inserted into the insertion opening 100, in particular to automatically connect the electrical wire 2 to the connection terminal 1 by detaching the clamping leg 120.

The detachment element 13 has an opening 131 with which the actuation element 14 engages via a locking portion 143 in the form of a projection when the actuation element 14 has been transferred into the actuated position shown in FIG. 5 in an actuating direction B. In the actuated position, the actuation element 14 engages in the opening 131 by means of the locking portion 143 and is thereabove held, so as to be locked, on the detachment leg 130, so that the actuation element 14 is locked in the actuated position.

In the illustrated exemplary embodiment, the detachment leg 130 is bent. Between a free end 138 of the detachment leg 130 remote from the supporting end 132 and a leg portion 137 of the detachment leg 130 aligned with the supporting end 132 and in which the opening 131 is formed, an intermediate portion 136 extends transversely between the free end 138 of the detachment leg 130 and the leg portion 137 of the detachment leg 130 bearing the opening 131. By suitably shaping the detachment element 13, the detachment element 13 can be adapted to the installation space conditions within the receiving space 101 of the housing 10.

If the actuation element 14 is actuated in the actuating direction B and thereby pivoted around the pivot shaft 140 relative to the housing part 10 into the actuated position according to FIG. 5, the actuation element 14 entrains the clamping leg 120 of the spring element 12 via an active portion 144 and thereby moves the clamping leg 120 into a release position. In the release position, the free end of the clamping leg 120 is removed from the contact portion 110 of the contact element 11 and thus releases a region, aligned with the insertion opening 100 in the insertion direction E, within the receiving space 101 such that an electrical wire 2 can be inserted into the insertion opening 100, unhindered by the clamping leg 120, and thus connected to the connection terminal 1 substantially without any force.

If an electrical wire 2 with a stripped conductor end 20 is inserted into the insertion opening 100 and thereby introduced into the receiving space 101 in the insertion direction E while the actuation element 14 is in the actuated position and thus the clamping leg 120 is in the release position, the wire 2 comes into abutment with the end portion 138 of the detachment leg 130 of the detachment element 13 and elastically deflects it relative to the supporting end 132 and thus to the housing part 10. As a result, the detachment leg 130 is moved in the insertion direction E relative to the locking portion 143 of the actuation element 14 so that the locking portion 143 disengages from the opening 131, and thus the actuation element 14 is released from the actuated position.

On a side, facing the free end 138 of the detachment leg 130, of the opening 131, a run-on element 133 is formed by a bent portion of the detachment element 13, formed as a sheet metal element, against which the locking portion 143 rests in the locking position and onto which the locking portion 143 runs when the locking engagement is detached.

Since the electrical wire 2 acts upon the detachment leg 130 with a lever arm that is larger than the lever arm acting upon the locking portion 143, the detachment leg 130 can be deflected with little force, to be applied by the electrical wire 2, and thus the locking engagement can be released easily and reliably when the electrical wire 2 is inserted.

As can be seen from FIG. 5 in conjunction with FIG. 7B, the run-on element 133 is bent in a direction towards the leg portion 137 of the detachment leg 130 which faces away from the actuation element 14 in the insertion direction E. In the locked position, in which the locking portion 143 engages in the opening 131, the locking portion 143 comes to rest at a contact point C on the run-on element 133 that is offset from a plane P along which extends the supporting portion 137 aligned with the supporting end 132. As a result, when the actuation element 14 engages the detachment element 13 by the locking portion 143 engaging in the opening 131 in the leg portion 137, the actuation element 14 exerts a torque on the detachment element 13 via the locking portion 143, which torque is directed in a counterclockwise direction in the sectional view according to FIG. 5 and thus in a direction that additionally reinforces the locking engagement between the locking portion 143 and the opening 131.

When the locking engagement is established, the detachment leg 130 is elastically deflected and the locking portion 143 slides into the opening 131, and the detachment leg 130 then returns to its initial position in which the detachment leg 130 engages the locking portion 143 of the actuation element 14. The detachment leg 130 is loaded by the locking portion 143 of the actuation element 14 on the run-on element 133 and is pushed in the direction of the actuation element 14 by the resulting torque such that the locking portion 143 moves into complete engagement with the opening 131 in the leg portion 137.

After the locking engagement is released when an electrical wire 2 is inserted, the actuation element 14 moves out of the actuated position due to the elastic preload on the clamping leg 120 and is returned counter to the actuation direction B. The clamping leg 120 comes into clamping abutment with the electrical wire 2 and thereby pushes the conductor end 20 into contacting abutment with the contact element 11 so that the wire 2 is electrically connected to the connection terminal 1 and is also mechanically locked.

Since the actuation element 14 is moved out of the actuated position after the locking engagement is detached, a user can safely and reliably detect that the connection terminal 1 has been detached, and the electrical wire 2 is thus connected to the connection terminal 1. The risk of incorrect operation is thus reduced.

If the electrical wire 2 is to be detached from the connected position and again removed from the connection terminal 1, the actuation element 14 can be transferred back into the actuated position so that the clamping leg 120 is not in abutment with the wire 2. The wire 2 can thus be removed from the connection terminal 1 substantially without any force.

In the illustrated exemplary embodiment, a housing part 10, 10A, 10B is assigned to each connection terminal 1, 1A, 1B.

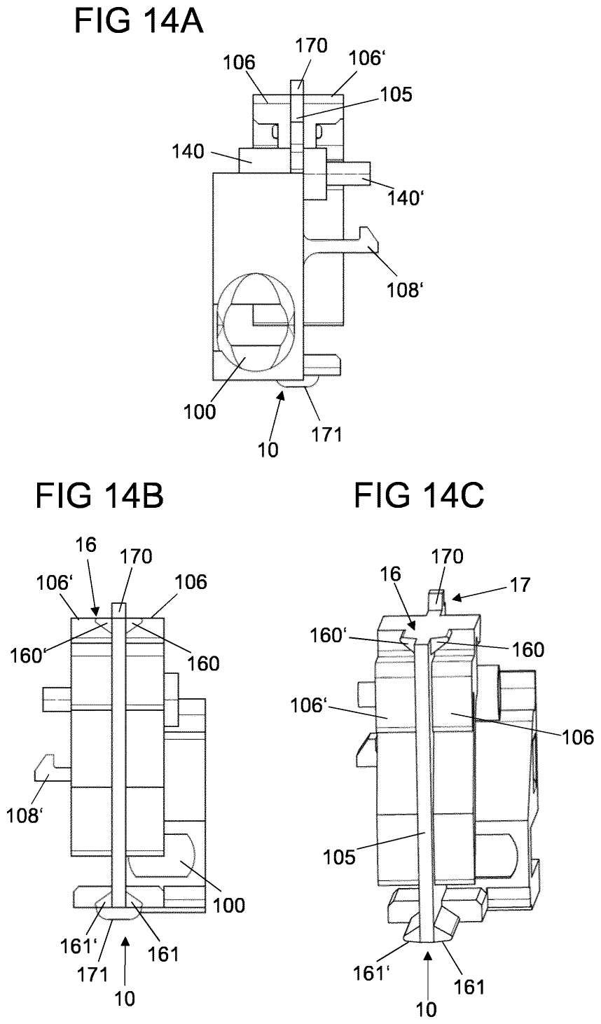

The housing parts 10, 10A are each designed like the housing parts 10, 10A according to FIG. 6A, 6B and the housing part 10 according to FIG. 14A, 14B, 14C. Each of these housing parts 10, 10A has a central wall 105, from which a raised wall portion 106 protrudes on a first side, which forms the engagement opening 107 and the connecting device 103, and from which, on a second side facing away, a raised wall portion 106′ protrudes, which portion forms an engagement opening 107′ and a connecting device 103′. The housing part 10, 10A thus serves on the first side to receive, support, and store the components of the connection terminal 1, 1A, 1B to which the housing part 10, 10A is assigned, and forms the insertion opening 100 on the first side for inserting an electrical wire 2. On the rear, second side, the housing part 10, 10A serves to complete the housing of an adjacent connection terminal 1, 1A, 1B.

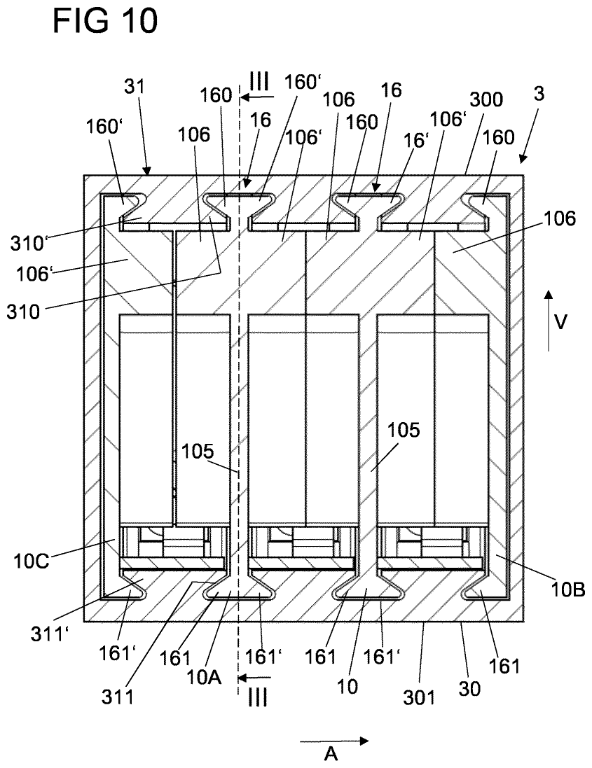

As can be seen from the sectional view according to FIG. 10, the housing parts 10, 10A are accommodated centrally in the outer housing 30 of the connection assembly 3. Outer housing parts 10B, 10C each have a central wall 105, but have a wall portion 106 or 106′ on only one side. Thus, the housing part 10B is attached to the housing part 10 and has only a wall portion 106, but no wall portion 106′ on the rear side. The housing part 10C, on the other hand, is attached to the housing part 10A and thus completes the housing for the connection terminal 1A, and for this purpose has only a wall portion 106′ but no wall portion 106, as can be seen from FIG. 10.

In the illustrated exemplary embodiment, the housing parts 10, 10A, 10B of the connection terminals 1, 1A, 1B are attached to one another along the row direction A, as is illustrated in FIGS. 6A and 6B by the housing parts 10, 10A. The housing part 10, 10A, 10B of a connection terminal 1, 1A, 1B is completed by the housing part 10, 10A, 10B of the adjacent connection terminal, so that the housing parts 10, 10A, 10B together form a housing for the connection terminals 1, 1A, 1B.

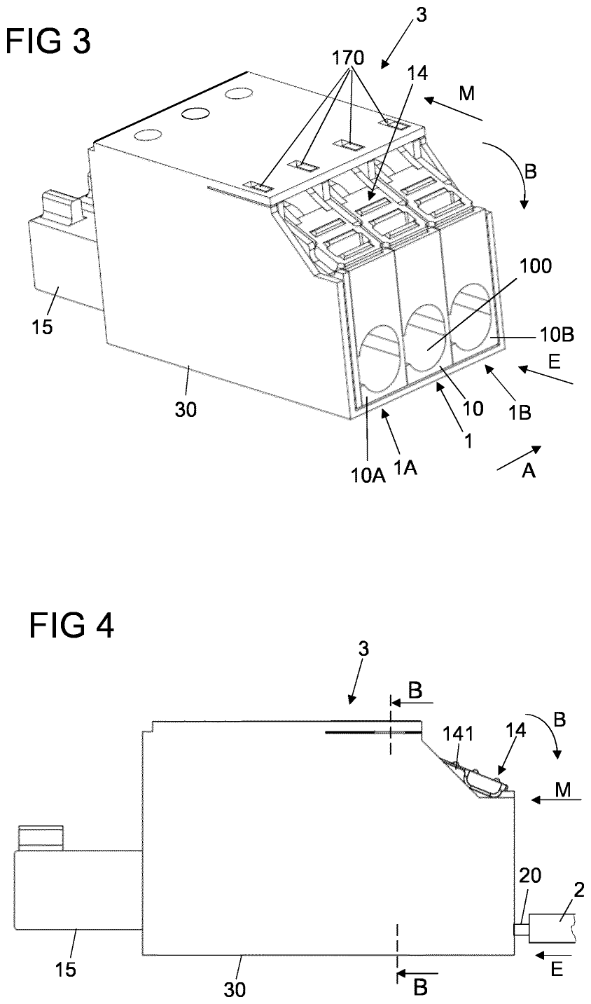

To assemble the connection assembly 3, the housing parts 10, 10A, 10B are inserted into the outer housing 3 in a position arranged in a row in an assembly direction M, in order to in this way enclose the connection terminals 1, 1A, 1B in the outer housing 30, as can be seen from FIGS. 1 and 3.

The housing parts 10, 10A, 10B, 10C each have a guide device 16 with guide webs 160, 160′, 161, 161′, which are guided on associated guide webs 310, 310′, 311, 311′ of a guide device 31 of the outer housing 3, as can be seen from FIG. 10. The guide devices 16, 31 realize a dovetail guide, via which the housing parts 10, 10A, 10B, 10C can be inserted into the outer housing 30 in a guided manner when the housing parts 10, 10A, 10B, 10C are attached to one another.

As can be seen from FIG. 10 in conjunction with FIG. 6A, 6B and FIG. 14A-14C, the two middle housing parts 10, 10A each have two guide webs 160, 160′ on an upper edge of the wall 105 and two guide webs 161, 161′ on a lower edge of the wall 105, which protrude from the wall 105 on both sides and together form a trapezoidal shape. The upper and lower pair of guide webs 160, 160′ and 161, 161′ thus formed can each be inserted between an associated pair of guide webs 310, 310′ and 311, 311′ on a top wall 300 and a bottom wall 301 of the outer housing 30, respectively, in order to thereby bring the housing parts 10, 10A, 10B, 10C into engagement with the outer housing 30.

As can be seen from FIG. 10, the two outer housing parts 10B, 10C each have only guide webs 160, 160′, 161, 161′ on one (inward-facing, inner) side of the wall 105, which webs interact with associated guide webs 310, 310′, 311, 311′ of the guide device 31 of the outer housing 30.

The introduction of the housing parts 10, 10A, 10B, 10C arranged in a row is carried out in a guided manner by pushing the guide webs 160, 160′, 161, 161′, which are trapezoidal in cross-section, onto the guide webs 310, 310′, 311, 311′ on the outer housing 30, which are complementary in cross-section to the first webs, as can be seen from FIG. 10.

The guide webs each form an undercut with respect to a vertical direction V perpendicular to the assembly direction M and the row direction A, so that the housing parts 10, 10A, 10B, 10C are supported in a form-fitting manner relative to the outer housing 30 in all spatial directions in the sectional plane according to FIG. 10, corresponding to a plane perpendicular to the assembly direction M, but are guided on the outer housing 30 so as to be displaceable along the assembly direction M.

By providing the outer housing 30, the advantages of a disk-shaped, modular design of the individual connection terminals 1, 1A, 1B are combined with a self-contained connection block (also referred to as a monoblock). The housing parts 10, 10A, 10B, 10C can each be designed to be open on one side, thus enabling easy attachment and assembly of the components of the connection terminals 1, 1A, 1B. By attaching the housing parts 10, 10A, 10B, 10C, the housing for the connection terminals 1, 1A, 1B is completed, wherein, after inserting the housing parts 10, 10A, 10B, 10C arranged in a row into the outer housing 30, a uniform, mechanically stable connection assembly 3 is created, in which the housing parts 10, 10A, 10B, 10C are mechanically firmly received and connected by the outer housing 30.

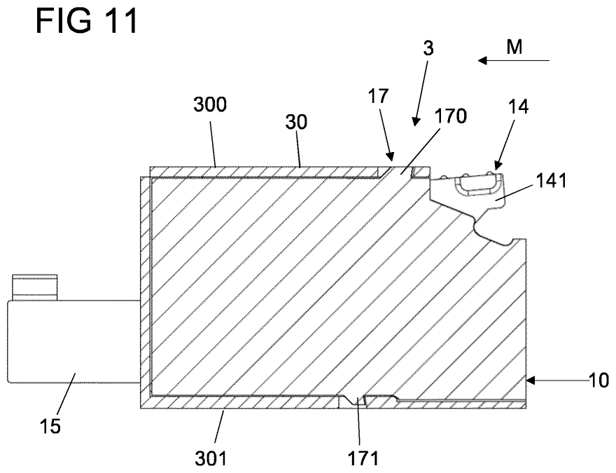

On the wall 105 of the central housing parts 10, 10A, an axial securing device 17 is formed in which locking lugs 170, 171 protrude from the wall 105 at an upper edge and at a lower edge. In the assembled position, shown in the sectional view according to FIG. 11, the locking lugs 170, 171 engage in associated locking openings on the top wall 300 and the bottom wall 301 of the outer housing 30.

The outer housing parts 10B, 10C have, for example, an upper locking lug 170 for engaging in an associated locking opening on the top wall 300 of the outer housing 30, but no lower locking lug 171.

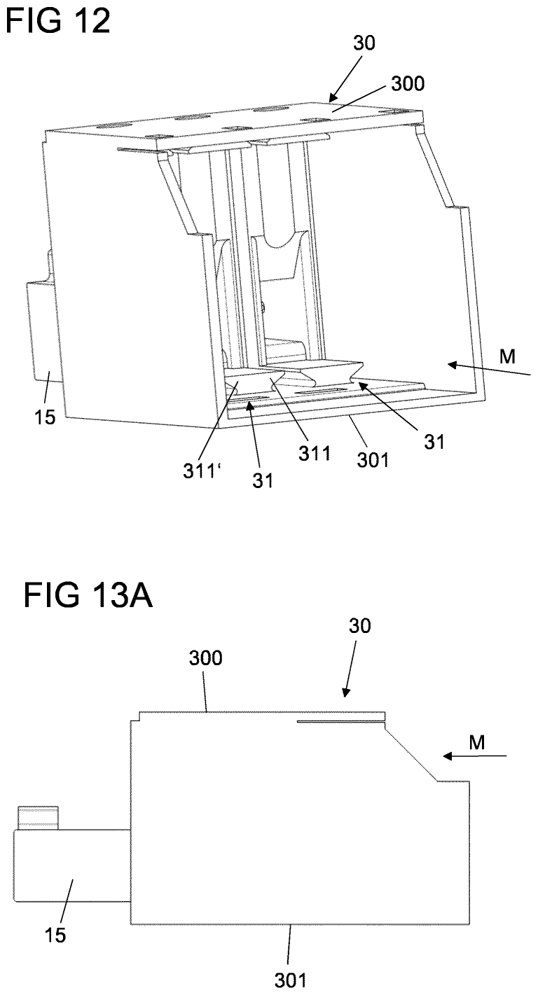

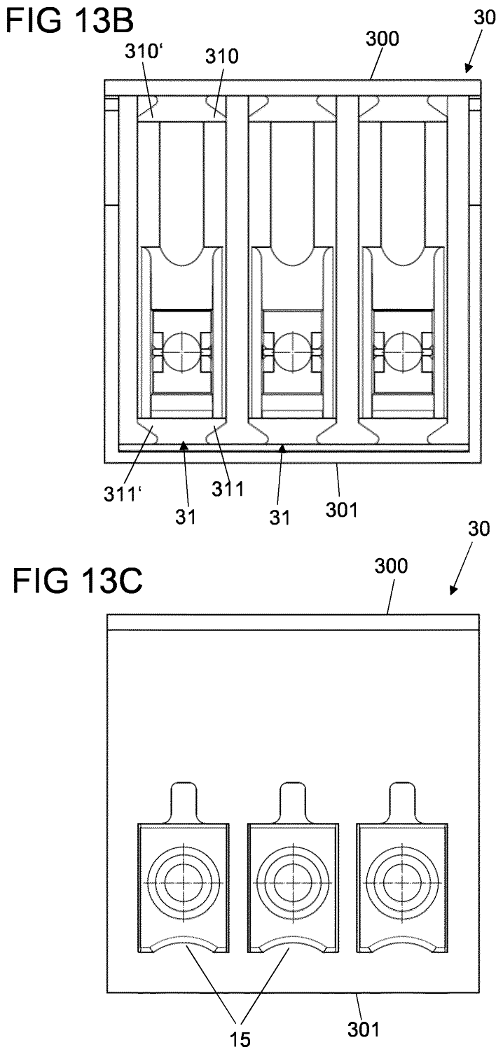

FIGS. 12 and 13A-13C show separate views of the outer housing 30. The dovetail-shaped arrangements of the webs 310, 310′, 311, 311′ of the guide device 31 on the top wall 300 and the bottom wall 301 of the outer housing 30 are visible.

On the wall 105 of the housing parts 10, 10A, 10C, a locking element 108′ in the form of a spring tongue is formed on the second side in each case, which tongue engages with an associated locking opening 108 on an adjacent housing part 10, 10A, 10B when the housing parts 10, 10A, 10B, 10C are attached, so that the housing parts 10, 10A, 10B, 10C are pre-assembled on one another and held together in a locking manner when attached along the row direction A. After inserting the pre-assembled assembly thus created into the outer housing 30, the connection assembly 3 is assembled and is mechanically stable due to the enclosure of the outer housing 30.

In the illustrated exemplary embodiment, each connection terminal 1, 1A, 1B is assigned a plug connector portion 15 which is formed on the outer housing 30 and in which a contacting device 111 of the correspondingly assigned contact element 11 is located.

The concept upon which the invention is based is not limited to the exemplary embodiment described above, but can also be realized in another way.

While, in the exemplary embodiment described above, all connection terminals of the connection assembly are implemented by a functionally identical spring-loaded connection, this is not mandatory. The connection terminals of the connection assembly can also differ from one another in terms of their function and design.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1, 1A, 1B, 1B Connection terminal
10, 10A-C Housing part
100 Insertion opening
101 Receiving space
102 Actuating opening
103, 103′ Connection device
104, 104′ Form-fitting element
105 Wall
106, 106′ Wall portion
107, 107′ Engagement opening
108, 108′ Locking element
11 Contact element (current bar)
110 Contact portion
111 Contacting device
12 Clamping spring
120 Clamping leg
121 Supporting leg
122 Intermediate portion
13 Detachment element
130 Detachment leg
131 Locking element (Locking opening)
132 Supporting end
133 Run-on element
134, 135 Form-fitting element (recess)
136 Intermediate portion
137 Leg portion
138 End
14 Actuation element
140 Pivot shaft
141 Actuating portion
142 Through-opening
143 Locking portion
144 Active portion
15 Plug connector portion
16 Guide device
160, 160′ Guide web
161, 161′ Guide web
17 Axial securing device
170, 171 Locking element
3 Connection assembly
30 Outer housing
300 Top wall
301 Bottom wall
31 Guide device
310, 310′ Guide web
311, 311′ Guide web
A Row direction
B Actuation direction
C Contact point
E Plug-in direction
M Assembly direction
V Vertical direction

1. A connection assembly, comprising:
a plurality of connection terminals configured to connect electrical wires, each connection terminal of the plurality of connection terminals having a housing part, a contact element arranged on the housing part with a contact portion configured to electrically contact an electrical wire, and a spring element with a clamping leg which is adjustable relative to the housing part and which is configured to act, in a clamping position, upon the electrical wire for contacting the contact portion; and
an outer housing into which the housing parts, which are arranged in a row along a row direction, of the plurality of connection terminals are insertable in an assembly direction, the outer housing having a first guide device with at least one first guide web, the housing parts being arranged in the row having a second guide device with at least one second guide web,
wherein the at least one second guide web of the second guide device is configured to be guided on the at least one first guide web of the first guide device when the housing parts arranged in the row are inserted into the outer housing in the assembly direction.

2. The connection assembly of claim 1, wherein at least one of the housing parts has at least one second guide web which configured to be guided on an associated first guide web of the first guide device.

3. The connection assembly of claim 2, wherein the at least one of the housing parts has a wall extending along a plane perpendicular to the row direction, from which wall the at least one second guide web protrudes along the row direction.

4. The connection assembly of claim 3, wherein the at least one of the housing parts of the connection terminals has two second guide webs, which are arranged on opposite sides of the wall.

5. The connection assembly of claim 1, wherein the at least one first guide web and/or the at least one second guide web comprise a dovetail guide.

6. The connection assembly of claim 1, wherein the row direction and the assembly direction are perpendicular.

7. The connection assembly of claim 6, wherein the at least one first guide web and the at least one second guide web are undercut with respect to a vertical direction perpendicular to the assembly direction and the row direction, such that the at least one first guide web and the at least one second guide web are supported relative to one another along the vertical direction.

8. The connection assembly of claim 1, wherein the clamping leg of at least one of the connection terminals of the plurality of connection terminals is configured to push or pull the electrical wire into abutment with the contact element by spring force.

9. The connection assembly of claim 1, wherein the spring element of at least one of the connection terminals of the plurality of connection terminals has a supporting leg which is supported on the housing part and relative to which the clamping leg is elastically deflectable.

10. The connection assembly of claim 9, wherein the supporting leg is supported on a supporting portion of the housing part.

11. The connection assembly of claim 9, wherein the supporting leg of the spring element of the at least one of the connection terminals is supported on a housing part assigned to the connection terminal and on the housing part of a connection terminal of the plurality of connection terminals that is adjacent along the row direction.

12. The connection assembly of claim 1, wherein the clamping leg of at least one of the connection terminals in a release position is, compared to the clamping position, removed from the contact portion, and
wherein the clamping leg in the release position is held in position relative to the housing part.

13. The connection assembly of claim 12, wherein at least one of the connection terminals of the plurality of connection terminals has a detachment element configured to interact with the electrical wire, when plugged into the at least one of the connection terminals, to detach the clamping leg from the release position.

14. The connection assembly of claim 13, wherein the detachment element has a detachment leg,
wherein the housing part of the at least one connection terminal defines a receiving space into which the electrical wire is insertable by plugging into the at least one of the connection terminals, and
wherein the detachment leg extends in the receiving space for interaction with the electrical wire.

15. The connection assembly of claim 14, wherein the detachment element has a support end relative to which the detachment leg is elastically adjustable through interaction with the wire plugged into the at least one of the connection terminals.

16. The connection assembly of claim 15, wherein the support end of the detachment element of the at least one of the connection terminals is supported on a housing part assigned to the at least one of the connection terminals and on a housing part of a connection terminal that is adjacent along the row direction.

17. The connection assembly of claim 1, wherein at least one of the connection terminals of the plurality of connection terminals has an actuation element which is adjustably arranged on the housing part and which is adjustable from a non-actuated position into an actuated position so as to transfer the clamping leg into the release position.

18. The connection assembly of claim 17, wherein the actuation element is mounted on the housing part of the at least one of the connection terminals so as to be pivotable around a pivot shaft, and has an actuation portion for actuation by a user and an active portion configured to act upon the clamping leg.

19. The connection assembly of claim 18, wherein the actuation element of the at least one of the connection terminals is mounted on a housing part assigned to the at least one connection terminal and on a housing part of a connection terminal adjacent along the row direction.

20. The connection assembly of claim 1, wherein the housing part of at least one of the connection terminals has a first locking element, and a housing part of a connection terminal adjacent along the row direction has a second locking element, and
wherein the first locking element and the second locking element are locked together when housing parts of the connection terminals of the plurality of connection terminals are arranged in a row along the row direction.
